(19) United States
(12) Patent Application Publication
(10) Pub. No.: US 2013/0126596 A1
(43) Pub. Date: May 23, 2013

(54) METHODS AND APPARATUS FOR DETECTING INDICIA AND PROJECTING IMAGES RELATED TO THE DETECTED INDICIA

(71) Applicants: Donna Marie FLETCHER, Auburn, NY (US); Robert John HENNICK, Cayuga, NY (US); William H. HAVENS, Syracuse, NY (US)

(72) Inventors: Donna Marie FLETCHER, Auburn, NY (US); Robert John HENNICK, Cayuga, NY (US); William H. HAVENS, Syracuse, NY (US)

(73) Assignee: Honeywell International Inc. (d.b.a) Honeywell Scanning and Mobility, Fort Mill, SC (US)

(21) Appl. No.: 13/303,795

(22) Filed: Nov. 23, 2011

(51) Int. Cl. G06F 17/30

(52) U.S. Cl. 235/375

(57) ABSTRACT

Apparatus and devices are provided for detecting indicia and projecting images related to the detected indicia. The apparatus includes an indicia detecting system adapted to detect a decodable indicium, such as, a bar code, and an image projecting system adapted to project an image in response to the detected decodable indicium. The apparatus may include a memory storage adapted to store projection data for use by the image projecting system in projecting an image. The indicia detecting system includes a photo detector and image collecting optics, the image projecting system includes light sources and a light manipulation system. Methods of detecting indicia and projecting images related to the detected indicia are also provided.

### BACKGROUND OF THE INVENTION

1. Field of the Invention

The present invention relates, generally, methods and apparatus for detecting indicia, such as, bar codes, and projecting images related to the detected indicia, particularly, to hand held devices adapted to perform indicia detecting and image projecting.

2. Description of Related Art

Indicia reading apparatus for reading decodable indicia are available in multiple varieties. For example, minimally featured indicia reading apparatus devoid of a keyboard and display are common in point of sale applications. Indicia reading apparatus devoid of a keyboard and display are available in the recognizable gun style form factor having a handle and trigger button (trigger) that can be actuated by an index finger. Indicia reading apparatus having keyboards and displays are also available, often in a form where a keyboard and display is commonly located by the providing of a touch screen type display. Keyboard and display equipped indicia reading apparatus are commonly used in retail, shipping and warehouse applications. In a keyboard and display equipped indicia reading apparatus, a trigger button for actuating the output of decoded messages is typically provided in such locations as to enable actuation by a thumb of an operator. Indicia reading apparatus in a form devoid of a keyboard and display or in a keyboard and display equipped form are commonly used in a variety of data collection applications including retail point of sale applications, retail inventory applications, shipping applications, warehousing applications, security check point applications, patient care applications, and personal use, common where keyboard and display equipped indicia reading apparatus is provided by a personal mobile telephone having indicia reading functionality. Fixed mount indicia reading apparatus are also commonly available, e.g., installed under or near a countertop at a point of sale. Some indicia reading apparatus are adapted to read bar code symbols including one or more of one dimensional (1D) bar codes, stacked 1D bar codes, and two dimensional (2D) bar codes. Other indicia reading apparatus are adapted to read OCR characters while still other indicia reading apparatus are equipped to read both bar code symbols and OCR characters.

The proliferation of electronic devices, in particular, of hand-held devices, in the earlier 21st century is one hallmark of the advances made in electronic circuit miniaturization and electronic storage capacity. In addition to the advances in symbol detection, for example, bar code scanning, the art has recently seen the introduction of miniaturized projectors capable of projecting images, though at limited distances.

### SUMMARY OF ASPECTS OF THE INVENTION

The present invention in its several aspects provides apparatus, devices, and methods employing indicia detection and image projection, for example, projection of images related to the detected indicia. One embodiment of the present invention is an indicia detecting and image projecting apparatus comprising or including: an indicia detecting system adapted to detect a decodable indicium; and an image projecting system adapted to project an image in response to the detected decodable indicium, for example, a bar code or other indicia, such as Code 39, Interleaved 2 of 5, Code 128, UPC, EAN, Codabar, Data Matrix, QR-Code, Maxicode, Aztec Code, and PDF-417, among others. In one aspect, the apparatus may further include a memory adapted to store projection data, and wherein the apparatus may be adapted to retrieve projection data from the memory, for example, in response to the information contained in the decodable indicium and forward the retrieved projection data to the image projecting system. In another aspect, the indicia detecting system may include at least one photo detector, and image collecting optics adapted to direct light from the decodable indicium to the photo detector, for instance, to create an image on the photo detector. In another aspect, the image projecting system may include at least one light source, for example, two or more laser diodes or two or more light-emitting diodes (LEDs), and a light manipulation system adapted to project an image from the light produced by the light source.

Another embodiment of the invention is a method for detecting indicia and projecting an image in response to information contained in the detected indicia, the method comprising or including: detecting a decodable indicium; and projecting an image in response to the information contained in the detected decodable indicium. In one aspect, the detecting of the decodable indicium may be practiced by illuminating the indicium; and collecting at least one image of the illuminated indicium. In another aspect, projecting the image may be practiced by activating at least one light source and manipulating light from the at least one light source to form an image from the light produced by the at least one light source. In another aspect, the method may further comprise or include retrieving projection data related to the decodable indicia from a memory and generating an image from the retrieved projection data.

A further aspect of the invention is a hand held indicia detecting and image projecting device comprising or including an indicia detecting assembly comprising image collecting optics adapted to collect light from a decodable indicium, and at least one photo detector adapted to detect light directed by the image collecting optics; and an image projecting system adapted to project an image in response to the detected decodable indicium; wherein the device is adapted to retrieve projection data for use by an image projection system related to the decodable indicium, for example, related to the information contained in the decodable image, and provide the projection data to the image projecting system to produce the image. For projecting the image in response to a detected decodable indicium, in one example, the device can decode the decodable indicium to determine a decode message, utilize the decode message to retrieve the projection data (e.g., by keying a database or lookup table), and provide the projection data to the image projection system. In one aspect, the image projection system may include a plurality of laser diodes or light-emitting diodes, a plurality of stationery mirrors or prisms adapted to reflect light from the plurality of light-emitting diodes, and a plurality of rotatable mirrors adapted to reflect light from the plurality of stationery mirrors. In another aspect, the photo detector may be a two-dimensional sensor array with an optical system which may include appropriate beam shaping optics.

Details of these embodiments and aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic diagram of an indicia detecting and image projecting apparatus according to an aspect of the invention.

FIG. 2 is a block diagram of an indicia detecting and image projecting apparatus according to an aspect of the invention.

FIG. 3 is a block diagram of an indicia detecting system and image projecting system show in FIG. 2 according to an aspect of the invention.

FIG. 4 is a perspective view of indicia detecting and image projecting apparatus according to an aspect of the invention.

FIG. 5 is a perspective view of projection of images to a group with a hand-held device according to one aspect of the invention.

FIG. 6 is a perspective view of a projection of images to a group in a confidential manner with a hand-held device according to another aspect of the invention.

### DETAILED DESCRIPTION OF FIGURES

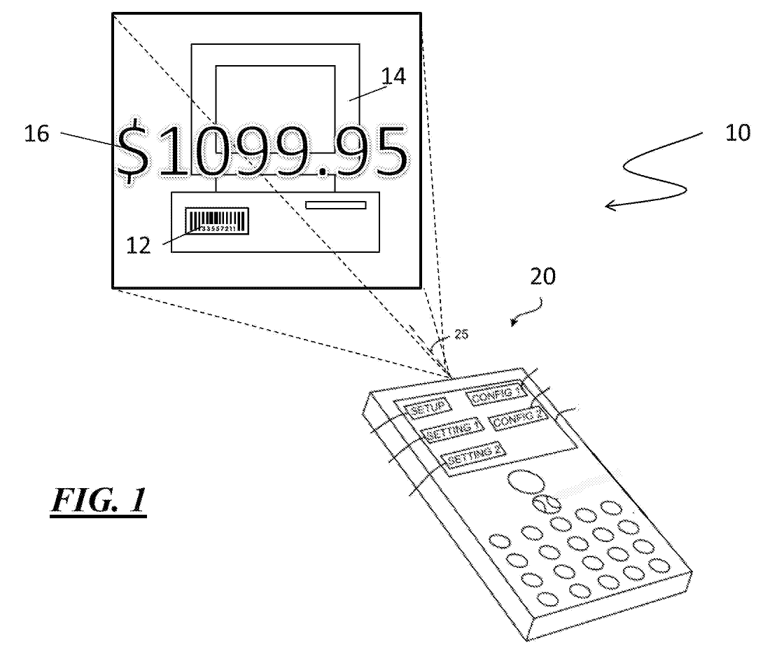

The details and scope of the aspects of the present invention can best be understood upon review of the attached figures and their following descriptions. FIG. 1 is a schematic diagram 10 of an indicia detecting and image projecting apparatus 20 according to one aspect of the invention. As shown in FIG. 1, apparatus 20 is adapted to detect a decodable indicium 12, for example, a one-dimensional code (for example, Code 3 of 9) or a two-dimensional code (for example, a PDF-417), for instance, an indicium located on an object 14, for instance, a piece of hardware, such as, a computer. Decodable indicium 12 may be, for example, printed on paper substrates, which are typically Lambertian scatterers, or alternately, retroreflective substrates, typically non-Lambertian scatterers, among other substrates. After decoding the indicium 12, apparatus 20 is adapted to project an image16 in response to the detected indicium 12, for example, the projected image 16 may be an image of the name, price, size, a specification, another barcode, or among other data that may be associated with indicium 12 and/or object 14.

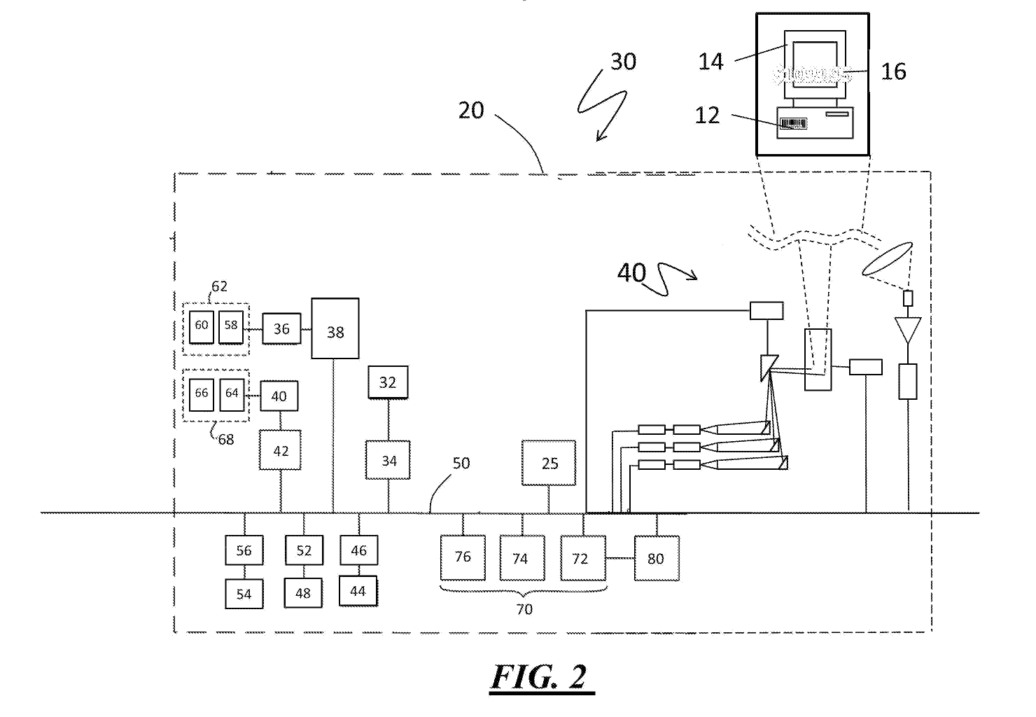

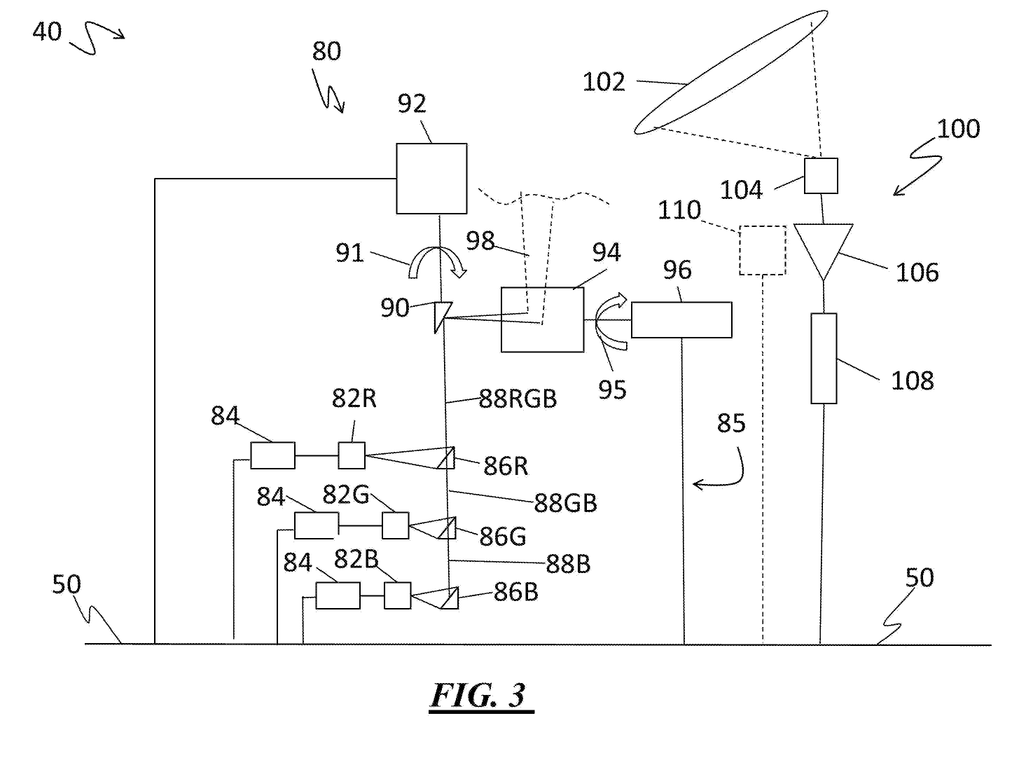

FIG. 2 is a block diagram 30 of an indicia detecting and image projecting apparatus 20 shown in FIG. 1 according to one aspect of the invention. Apparatus 20, for example, an indicia reading and/or detecting terminal, includes an indicia reading and image projection system 40. System 40 is adapted to detect a decodable indicium 12 and project an image 16 in response to the detected decodable indicium 12. Details of system 40 are provided in FIG. 3.

As shown in FIG. 2, in addition to system 40, apparatus 20 may also include a system address/data bus (system bus) 50 adapted to permit communication between system 40, a central processing unit (CPU) 25, and various components, controls, interfaces, and interface circuits for coupling various peripheral devices to apparatus 20 and powering and controlling apparatus 20. For example, apparatus 20 may include a CPU 25; an electrical power input unit 32, for example, coupled to system bus 50 by interface circuit 34; an illumination light source bank control circuit 36, for example, coupled to system bus 50 by interface circuit 38; an aiming light source bank control circuit 40 coupled to system bus 50 by interface circuit 42; and a trigger 44, for example, coupled to system bus 50 by interface circuit 46. Apparatus 20 may also include a display 48, for example, coupled to system bus 50 and in communication with CPU 25, via interface 52, and may include a pointer mechanism 54 in communication with CPU 25 via interface 56 connected to system bus 50.

Trigger 44 may be used to activate a trigger signal for activating frame readout and/or certain decoding processes. Apparatus 20 may be adapted so that activation of trigger 44 activates a trigger signal and initiates a decode attempt. Specifically, apparatus 20 may be operative so that in response to activation of a trigger signal, a succession of frames can be read out and captured by way of read out of image information from image sensor 104 (see FIG. 3), typically in the form of analog signals, and then storage of the image information after analog to digital conversion into memory 70 (which can buffer one or more of the succession of frames at a given time). CPU 25 may be operational to subject one or more of the succession of frames to a decode attempt. For attempting to decode an indicium, such as, a bar code symbol, CPU 25 may process image data of a frame corresponding to a line of pixel positions (for example a row, a column, or a diagonal set of pixel positions when sensor 104 (see FIG. 3) comprises an array sensor) to determine a spatial pattern of dark and light cells and may convert each light and dark cell pattern determined into a character or character string via, for example, a table lookup, for output of decode data (decoded image data), e.g., in the form of a character string.

Apparatus 20 may also include an illumination pattern light source bank 58 and associated light shaping optics 60 for generating an illumination pattern on object 14 substantially corresponding to a field of view of apparatus 20. The combination of bank 58 and optics 60 may comprise an illumination pattern generator 62. Apparatus 20 may also include an aiming pattern light source bank 64 and associated light shaping optics 66 for generating an aiming pattern on the object 14. The combination of bank 64 and optics 66 may comprise an aiming pattern generator 68.

In the course of operation of apparatus 20, indicia 12 may be detected, decoded, and stored in and corresponding image signals may be identified and read from a system memory 70, such as, RAM. A memory 70 of apparatus 20 may include RAM 72; a nonvolatile memory 74, such as, an EPROM; and a storage memory device 76, such as, a flash memory or a hard drive memory. In one embodiment, apparatus 20 may include a CPU 25 which can be adapted to read out image data stored in memory 72 and subject such image data to various image processing algorithms. Apparatus 20 may also include a direct memory access unit (DMA) 80, for example, for routing image information that has been subject to conversion to RAM 72. In another embodiment, apparatus 20 may employ a system bus 50 providing for bus arbitration mechanism (for example, a PCI bus), thus eliminating the need for a central DMA controller. A skilled artisan would appreciate that other embodiments of the system bus architecture and/or direct memory access components providing for efficient data transfer between the image sensor, for example, photo detector 104 in FIG. 3, and memory 70 are within the scope and the spirit of the present invention.

FIG. 3 is an enlarged detailed view of indicia reading and image projection system 40 shown in FIG. 2. As shown in FIG. 3, system 40 includes an image projecting system 80 and an indicia detecting system 100 each operatively connected to system bus 50, for example, and operatively connected to CPU 25 and memory 70 (see FIG. 2). According to aspects of the invention, any projection system may be used for projecting system 80, for example, any system adapted to project an image from one or more light sources. In the aspect of the invention shown in FIG. 3, projecting system 80 includes at least one, but typically, a plurality of light sources 82 (for example, one or more red 82R, green 82G, and blue 82B, laser diodes). In the aspect shown, light sources 82 may be one or more semi-conductor-based light sources, for example, light-emitting diodes (LEDs), for instance, red, green, and blue LEDs or one or more laser diodes. Light sources 82 may each be operatively connected to a respective driver 84 coupled to system bus 50.

According to an aspect of the invention, light emitted from one or more light sources 82 is directed by a light manipulation system 85 adapted to project a two dimensional image from the light produced by the light sources 82, for example, by appropriate optics, e.g., image 16 shown in FIG. 1. In one aspect of the invention, mirrors or prisms 86 may be wavelength selective, for example reflection light substantially only within a specific wavelength, for example, red light, green light, or blue light, while transmitting the other colors. In the aspect of the invention shown in FIG. 3, light from sources 82 is directed to one or more rotatable mirrors 90 and 94, for example, via one or more mirrors or prisms 86 (for example, one of mirrors 86R reflecting red light, 86G reflecting green light, and 86B reflecting blue light from red laser diode 82R, green laser diode 86G, and blue laser diode 86B, respectively). As shown in FIG. 3, light from light sources 82 may be reflected off of mirrors or prisms 86 to rotating mirror 90 as indicated by light beams 88. As shown in FIG. 3, mirror or prism 86B may or may not be wave length selective for blue light whereby light received from source 82B is reflected as blue light beam 88B toward mirror or prism 86G. Mirror or prism 86G may be wavelength selective whereby only green light from light source 82G reflects from mirror or prism 86G while blue light beam 88B passes substantially unreflected through mirror or prism 86G and combines, for example, collinearly combines, with the green light from light source 82G reflected from mirror or prism 86G to produce a dual color, blue and green, light beam 88 GB. In like manner, mirror or prism 86R may be wavelength selective whereby only red light from light source 82R reflects from mirror prism 86R while green and blue light beam 88 GB passes substantially unreflected through mirror or prism 86R and combines, for example, collinearly combines, with the red light from light source 82R reflected from mirror or prism 86R to produce a multicolored, red, green, and blue, light beam 88RGB. Multicolored light beam 88RGB is directed to one or more rotatable mirrors 90 and 94 to create a two dimensional scan pattern or image with, e.g., 2 degrees of freedom. In some embodiments, the scan pattern or image is created without the need of coordinated operator hand motion, for example, hand swings, or a gyroscope to track operator hand motion. One or more rotatable mirrors 90, having a rotation as indicated by curved arrow 91, may typically be driven by a driver 92, for example, a vertical deflector and driver, operatively connected to system bus 50. The light reflected from rotatable mirror 90 is directed to one or more rotatable mirrors 94. Rotatable mirror 94, having a rotation as indicated by curved arrow 95, may also typically be driven by driver 96, for example, a horizontal deflector and driver, operatively connected to system bus 50. The light 98 directed by mirror 94 exits apparatus 20, for example, after manipulation by appropriate optics (not shown) and provides the image 16 on object 12 (see FIG. 1) according to aspects of the invention. Light sources 82 may also include appropriate beam forming optical elements such as collimating lenses, apertures, and/or phase masks associated with them as is well known in the art.

As also shown in FIG. 3, according to aspects of the invention, system 40 also includes an indicia detecting system 100 operatively connected to system bus 50. According to aspects of the invention, indicia detecting system 100 includes image collecting optics 102 adapted to receive an image from the decodable image or indicium, such as, a lens or similar optics adapted to capture an image, for example, an image of indicia 12 (see FIG. 1) and direct light rays from the image to photo detector 104, for example, an image sensor. In another aspect of the invention, photo detector 104 may comprise a sensor array, for example, a CCD or CMOS imager or another one- and/or two-dimensional sensor array, such as, the sensor arrays disclosed in U.S. patent application Ser. No. 11/174,447 filed on Jun. 30, 2005 [herein “the '447 application”], now U.S. Pat. No. 7,780,089 (other patents pending), marketed under the term “MonoColor” imaging. (The disclosure of the '447 application is included by reference herein in its entirety.) Photo detector 104 may be a photodiode adapted to detect laser light, for example, laser light reflected from the image under examination.

Optics 102 may be adapted for focusing an image of decodable indicia 12 (in FIG. 1) located within a field of view onto photo detector 104, such as, an image sensor array. Optics 102 may be adapted to be capable of multiple focal lengths and multiple best focus distances.

Indicia detecting system 100 may capture frames of image data at a rate known as a frame rate. A typical frame rate is 60 frames per second (FPS) which translates to a frame time (frame period) of 16.6 milliseconds (ms). Another typical frame rate is 30 frames per second (FPS) which translates to a frame time (frame period) of 33.3 ms per frame.

As shown in FIG. 3, in one aspect, indicia detecting system 100 may include a light source 110 (shown in phantom). Light source 110 may be provided to illuminate the image detected by photo detector 104, for example, a decodable image or indicium, such as, a one-dimensional code or a two-dimensional code, and the like. For example, light source 110 may be a scanning laser light source, as known in the art. However, in one aspect of the invention, light source 110 may be omitted and the decodable image may be illuminated by projecting system 80, for example, by one or more light sources 82R, 82G, and 8213 (for example, one or more red, green or blue laser diodes, respectively). For example, in one aspect, projecting system 80 may function as both an image projector and an image illuminator, for example, for indicia detecting system 100. In another embodiment light source 110 may be an illumination system comprising one or more LEDs, either red, green, blue or white as is well known in the art. In some embodiments, when photo detector 104 comprises a CCD or CMOS imager or another one- and/or two-dimensional sensor array, light source 110 may include illumination focusing optical elements comprising one or more lenses or reflective elements.

In another embodiment, the scanning beam of the projector can be directed to sweep or traverse across the decodable indicium being read. The energy scattered from the indicium, for example, a bar code, may then be focused, for example, by lens 102, onto a photo detector 104 (for example, an image detector or, preferably, a photo diode). The scattered light may be modulated by the reflection characteristics of the indicium being scanned and thus cause modulation of the current generated by photo detector 104. The scanning pattern may be a single line scanning pattern or a raster-type scanning pattern (for example, repeated linear scanning of offset rows) thereby enabling aspects of the invention to scan both one-dimensional linear indicia, such as, UPC bar codes or “code 3 of 9” bar codes; stacked linear bar codes, such as, PDF 417 codes; and/or matrix codes, such as, MAXI codes or QR codes.

As shown in FIG. 3, the image data captured by photo detector 104 may be processed by amplifier 106 and digitizer 108 prior to being forwarded to system bus 50, for example, for processing by CPU 25 or storage memory 70, among other handling of image data, for indicia decoding for output of decode data.

According to one aspect of the invention, the decodable image detected by indicia detecting system 100 may provide an indication of what image may be projected by projector system 80. For example, in one aspect, the image or images projected by projecting system 80 may be an image or images associated, linked, or somehow related to the decodable image detected by indicia detecting system 100. For instance, the decodable image detected by indicia detecting system 100 may be associated with an image file, a text message, a video file, and/or a holographic (that is, two or three dimensional) image that can be displayed by projecting system 80, for example, projected on or adjacent to the detected indicia, for example, on or adjacent to bar code 12 shown in FIG. 1, or projected on or adjacent to an object associated with bar code 12, for example, device 14 shown in FIG. 1. In one aspect, the image projected by projecting system 80 may be projected in a location that does not interfere, obscure, or be superimposed on the image detected by indicia detecting system 100 and/or interfere with or obscure the view of the image by the user. The projection data associated with the decoded image may be stored in the form of a database or look-up table, among other storage and retrieval systems. The projection data associated with the detected decodable image may be stored “on board,” for example, in memory 70; and/or the projection data may be stored remotely, for example, in a remote memory, and accessed via wires or wirelessly, for example, stored on a network wirelessly coupled to apparatus 20. In one aspect, the projection data accessed by system 80 may be obtained from the device bearing the decodable image, for example, a storage device that can be “unlocked” and therefore accessible, for example, wirelessly, by detection and decoding of the decodable image.

In one aspect, the image projected by projecting system 80 may comprise user instructions or feedback. For example, projecting system 80 may display an image that the image was successfully detected (for example, projecting the image “CODE DETECTED”), or that the image was successfully decoded (“INDICIUM DECODED”). Projecting system 80 may also project or provide audio feedback instructions to the user, for example, “MOVE CLOSER,” when the indicia detecting system 100 fails to detect or read an image due, for example, to poor resolution or insufficient illumination, among other user instructions.

In another aspect of the invention, the one or more images projected by projecting system 80 may include one or more decodable indicia detectable by detecting system 100. For example, projecting system 80 may project an image of a one-dimensional or a two-dimensional indicium that can be detected by detecting system 100, and decoded according to aspects of the invention. The image projected by projecting system 80 may be based upon the detection of an image by detecting system 100, or the image projected by projecting system 80 may be independent of the detection of an image by detecting system 100. For example, an image can be projected by projecting system 80 based upon an image detected by detecting system 100, and then the projected image can be detected by detecting system 100 to verify or confirm the accuracy of the projected image, for instance, in a “feed back” loop.

In another aspect of the invention, an image projected by projecting system 80 may be detected or read by another device, different from indicia detecting and image projecting apparatus 20 (shown in FIG. 1), which is adapted to decode the image projected by projecting system 80. One aspect the invention may comprise a security system where an image, for example, a unique decodable indicium, may be projected by one apparatus 20, and the decodable indicium detected and decoded by another apparatus 20, or by a different apparatus adapted to detect and decode the indicium projected by apparatus 20. For example, in one aspect, a first apparatus 20 may project an indicium that may be detected and decoded by a second apparatus 20, or similar apparatus, before at least one or both of the first and second apparatuses 20 will operate or be able to execute an operation or routine. In another aspect, a first apparatus 20 may project an indicium that may be detected and decoded by a second apparatus 20, or similar apparatus, that is operatively connected to a device (not shown) in which the device can only operate, execute an operation, or effect a function when the second apparatus 20 accurately detects and decodes the indicium projected by the first apparatus 20. Other functions of detecting an indicium projected by projecting system 80 which can be detected by detecting system 100 will be apparent to those of skill in the art.

Images that may be projected by projecting system 80 may include, but are not limited to, prices (as indicated in FIGS. 1 and 2), dimensions, availability, comparable units, comparable unit prices, locations, specifications (for example, hardware specifications), drawings (for example, hardware drawings), displays, videos, pictures, and maps, among other information. However, the image projected by projecting system 80 may be any image in anyway associated with the decodable image and/or the information contained in the decodable image detected by indicia detecting system 100

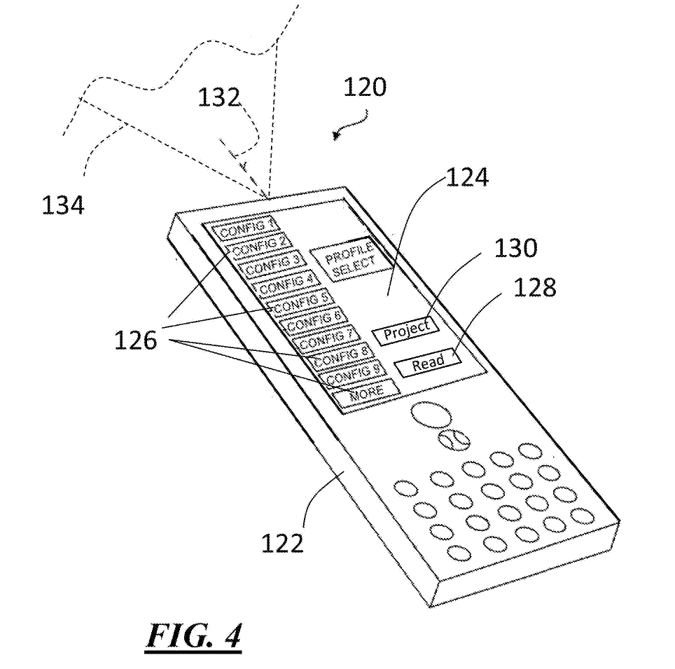

FIG. 4 is a perspective view of an apparatus, for example, a hand-held device or terminal, 120 that may employ aspects of the present invention, for example, the systems shown in FIGS. 2 and 3. As shown in FIG. 4, apparatus 120 includes a housing 122 having a display 124, for example, an LCD or LED display. The display 124 may typically display a graphical user interface (GUI) having a plurality of icons 126 for user input, manipulation, or activation of predetermined routines. According to aspects of the present invention, apparatus 120 may include at least one icon or button 128 adapted to activate an indicia reading system, for example, indicia detecting system 100 shown in FIG. 3, and may include an icon or button 130 adapted to activate a projector system, for example, projecting system 80 shown in FIG. 3. For example, as shown in FIG. 4, the selection of the “Read” icon 128 may activate detecting system 100 whereby an image toward which apparatus 120 is directed, for example, along axis 132, may detect a decodable image, for example, a bar code 12 shown in FIG. 1. According to aspects of the invention, either immediately after detection of a decodable image 12 by system 100, for example, without input or direction from the user, or by selection of “Project” icon 130, an image related to decodable image 12 (for example, an image retrieved from memory 70) is projected from apparatus 120 by projecting system 80, for example, as indicated by image lines 134 shown in FIG. 4, for instance, image 16 shown in FIG. 1.

Though the illustration of one aspect of the invention shown in FIG. 4 indicates that the image detection and the image projection may be received and directed, respectively, from an end of apparatus 120, according to aspects of the invention, image detection and image projection may be provided from any surface of housing 122. For example, from a top surface, that is, the surface having display 124; or a bottom surface, that is, the surface opposite the surface having display 124, or from any one or more of the lateral or side surfaces of housing 122. In one aspect, image data may be received and projection data may be projected from the same surface of housing 122, for example, as shown in FIG. 4 where the image is received and the image is projected from a top edge of housing 122. However, according to an aspect of the invention, image detection and image projection may be provided from different surfaces of housing 122. For example, image detection may be provided from the top edge of housing 122, as shown in FIG. 4, while image projection may be provided from the bottom surface of housing 122, that is, from the surface opposite display 124. Other configurations and relative physical locations for image detection and image projection will be apparent to those of skill in the art.

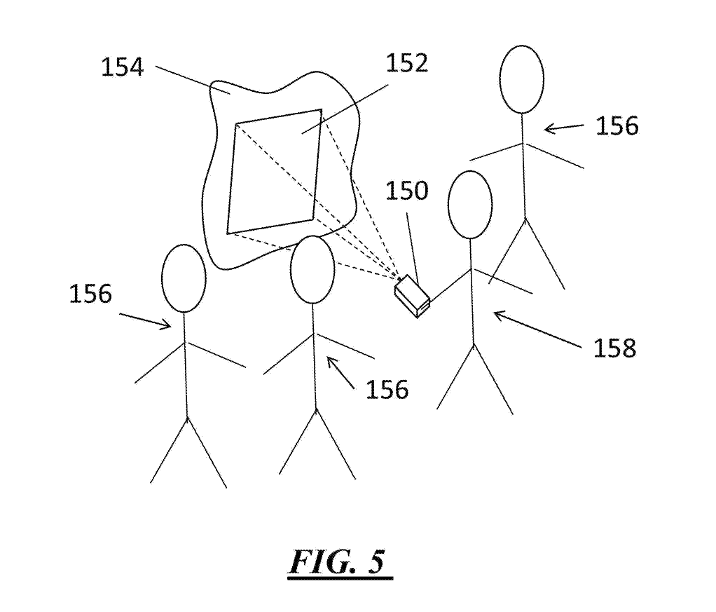

In one aspect of the invention, the indicia detecting and image projecting apparatus 20, 120 shown in FIGS. 1, 2, 3, and 4 may be adapted to display one or more images to a group. FIG. 5 is a perspective view of a projection of one or more images wherein the images can be viewed by one or more individuals, for example, to a group, with a device 150, for example, a hand-held device, according to one aspect of the invention. Device 150 may comprise any one of the devices or apparatuses disclosed herein, including apparatus 20 or hand-held device or terminal 120. According to one aspect of the invention, device 150 is adapted to project an image 152 upon a surface 154 whereby one or more individuals 156 may view image 152. Surface 154 may be any surface positioned to receive image 152 whereby image 152 may be at least partially viewable, typically, substantially viewable in its entirety, by one or more individuals 156, for example, a plurality of individuals 156. Surface 154 may be a wall, a screen, a board, or any surface positioned to receive image 152. As shown in FIG. 5, device 150 may be held, operated, and directed by an operator 158, though in one aspect, no operator is needed. In one aspect, the image 152 may be used for instruction, for example, for group instruction of military or safety personal, for class room instruction, for operating room instruction, or for entertainment, among other uses envisioned. In one aspect, device 150 may assist visitors to a museum, art gallery, or exhibition, and the like, to enhance the visitor's experience. For example, by projecting supplementary images, displays, text, and/or videos, and the like, for example, to a group or to a group led by a docent operating device 150 when viewing a piece of art work, display, or the like.

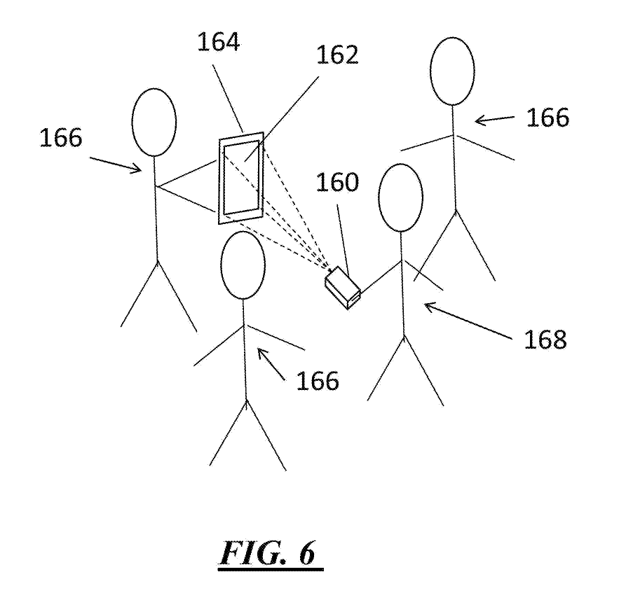

FIG. 6 is a perspective view of a projection of one or more images wherein the images can be viewed by one or more individuals, for example, to a group, but in a more confidential manner. In one aspect, a device 160, for example, a hand-held device, according to one aspect of the invention, may comprise any one of the devices or apparatuses disclosed herein, including apparatus 20 or hand-held device or terminal 120. According to one aspect of the invention, device 160 is adapted to project an image 162 upon a surface 164 whereby one or more individuals 166, and only individuals 166 may view image 162. Surface 164 may be any surface positioned to receive image 162 whereby the view of image 162 may be limited, typically, substantially limited to the immediate individuals 166. Surface 164 may be a pad of paper, a back or chest of an individual 166, the ground, a wall, or ceiling about individuals 166, or any surface positioned to receive image 162 while limiting viewability of image 162 to one or more individuals 166. According to one aspect, when projecting images as shown in FIGS. 5 and 6 no hardcopy, for example, paper copies, of images or information need be produced and, for example, need be destroyed to maintain confidentiality. As shown in FIG. 6, device 160 may be held, operated, and directed by an operator 168, though in one aspect, no operator is needed. In one aspect, the image 162 may be used for instruction, for example, for group instruction of military or safety personal, for class room instruction, for operating room instruction, or for entertainment, among other uses envisioned.

Aspects of the present invention provide devices and methods an apparatus for detecting and decoding decodable indicia and then projecting images related to the decoded indicia. The invention may be implemented in a broad range of fields, including, but not limited to, healthcare, education, retail, defense, security, safety, sports, entertainment, art, mapping, and signage. As will be appreciated by those skilled in the art, features, characteristics, and/or advantages of the various aspects described herein, may be applied and/or extended to any embodiment (for example, applied and/or extended to any portion thereof).

A small sample of systems methods and apparatus that are described herein is as follows:

A1. An indicia detecting and image projecting apparatus comprising:

an indicia detecting system adapted to detect and decode a decodable indicium; and

an image projecting system adapted to project an image in response to the detected decodable indicium,

wherein the apparatus is adapted to project an image in response to decoded image data of the decodable indicium.

A2. The apparatus as recited in claim 1, wherein the apparatus further comprises a memory adapted to store projection data; and wherein the apparatus is adapted to retrieve projection data from the memory in response to the decodable indicium and forward the retrieved projection data to the image projecting system.

A3. The apparatus as recited in claim 1, wherein the indicia detecting system comprises:

at least one photo detector; and

image collecting optics adapted to direct an image of the decodable indicium to the at least one photo detector.

A4. The apparatus as recited in claim 1, wherein the image projecting system comprises:

at least one light source; and

a light manipulation system adapted to project an image from the light produced by the light source.

A5. The apparatus as recited in claim 4, wherein the at least one light source comprises at least one semi-conductor-based light source.

A6. The apparatus as recited in claim 5, wherein the at least one semi-conductor-based light source comprises a plurality of laser diodes.

A7. The apparatus as recited in claim 4, wherein the light manipulation system comprises at least one stationary mirror adapted to reflect light from the at least one light source to at least one rotatable mirror.

A8. The apparatus as recited in claim 1, wherein the image projecting system provides illumination for the indicia detecting system.

A9. The apparatus as recited in claim 1, wherein the decodable indicium comprises one of a one-dimensional code and a two-dimensional code.

A10. The apparatus as recited in claim 1, wherein the apparatus comprises a hand held device.

A11. The apparatus as recited in claim A1, wherein the image projecting system is adapted to project an image viewable by a plurality of individuals.

A12. The apparatus as recited in claim A1, wherein the image projected by the image projecting system comprises a decodable indicium detectable by the image detecting system.

A13. The apparatus as recited in claim A2, wherein the memory adapted to store projection data comprises a remote memory.

A14. The apparatus as recited in claim A1, wherein the indicia detecting system comprises an image sensor array.

A15. The apparatus as recited in claim A14, wherein the image sensor array comprises one of a one-dimensional image sensor array and a two-dimensional image sensor array.

A16. The apparatus as recited in claim A1, wherein the indicia detecting system includes a light source, and wherein the image projecting system commonly includes the light source.

B1. A method for detecting indicia and projecting an image in response to the detected indicia, the method comprising:

detecting and decoding a decodable indicium; and

projecting an image in response to decoded image data of the detected decodable indicium.

B2. The method as recited in claim B1, wherein detecting the decodable indicium comprises:

illuminating the indicium; and

collecting at least one image of the illuminated indicium.

B3. The method as recited in claim B1, wherein projecting the image comprises:

activating at least one light source; and

manipulating light from the at least one light source to form an image from the light produced by the at least one light source.

B4. The method as recited in claim B1, wherein the method further comprises retrieving projection data related to the decodable indicia from a memory and generating the image from the retrieved projection data.

B5. The method as recited in claim B1, wherein the decodable indicium comprises one of a bar code and a QR code.

B6. The method as recited in claim B1, wherein the projected image is viewable by a plurality of individuals.

B7. The method as recited in claim B1, wherein the projected image comprises an indicium detectable by the image detecting system, and wherein the method further comprises detecting the indicium projected by the image projecting system.

B8. The method as recited in claim B4, wherein the memory comprises a remote memory.

B9. The method as recited in claim B2, wherein collecting at least one image of the illuminated indicium comprises collecting at least one image with an image sensor array.

B10. The method as recited in claim B9, wherein the image sensor array comprises one of a one-dimensional image sensor array and a two-dimensional image sensor array.

C1. A hand held indicia detecting and image projecting device comprising:

an indicia detecting assembly comprising image collecting optics adapted to collect light from a decodable indicium, and at least one photo detector adapted to detect light directed by the image collecting optics; and

an image projecting system adapted to project an image in response to the detected decodable indicium;

wherein the device is adapted to retrieve projection data related to the decodable indicium and provide the projection data to the image projecting system to produce the image.

C2. The device as recited in claim C1, wherein the image projection system comprises a plurality of laser diodes or light-emitting diodes, a plurality stationery mirrors adapted to reflect light from the plurality of laser or light-emitting diodes, and a plurality of rotatable mirrors adapted to reflect light from the plurality of stationery mirrors.

C3. The device as recited in claim C1, wherein the photo detector comprises a two-dimensional array.

C4. The device as recited in claim C1, wherein the device comprises a display having a graphical user interface.

C5. The device as recited in claim C1, wherein the decodable indicium comprises one of a one-dimensional code and a two-dimensional code.

C6. The device as recited in claim C6, wherein the image projecting system is adapted to project an image viewable by a plurality of individuals.

C7. The device as recited in claim C1, wherein the image projected by the image projecting system comprises a decodable indicium detectable by the indicia detecting assembly.

C8. The device as recited in claim C1, wherein the device is adapted to retrieve projection data related to the decodable indicium from a remote memory.

C9. The device as recited in claim C1, wherein the at least one photo detector comprises an image sensor array.

C10. The device as recited in claim C9, wherein the image sensor array comprises one of a one-dimensional image sensor array and a two-dimensional image sensor array.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

1. An indicia detecting and image projecting apparatus comprising:
an indicia detecting system adapted to detect and decode a decodable indicium; and
an image projecting system adapted to project an image in response to the detected decodable indicium,
wherein the apparatus is adapted to project an image in response to decoded image data of the decodable indicium.

2. The apparatus as recited in claim 1, wherein the apparatus further comprises a memory adapted to store projection data; and wherein the apparatus is adapted to retrieve projection data from the memory in response to the decodable indicium and forward the retrieved projection data to the image projecting system.

3. The apparatus as recited in claim 1, wherein the indicia detecting system comprises
at least one photo detector; and
image collecting optics adapted to direct an image of the decodable indicium to the at least one photo detector.

4. The apparatus as recited in claim 1, wherein the image projecting system comprises:
at least one light source; and
a light manipulation system adapted to project an image from the light produced by the light source.

5. The apparatus as recited in claim 1, wherein the indicia detecting system includes a light source, and wherein the image projecting system commonly includes the light source.

6. The apparatus as recited in claim 4, wherein the at least one light source comprises at least one semi-conductor-based light source.

7. The apparatus as recited in claim 4, wherein the light manipulation system comprises at least one stationary mirror adapted to reflect light from the at least one light source to at least one rotatable mirror.

8. A method for detecting indicia and projecting an image in response to the detected indicia, the method comprising:
detecting and decoding a decodable indicium; and
projecting an image in response to decoded image data of the detected decodable indicium.

9. The method as recited in claim 8, wherein detecting the decodable indicium comprises
illuminating the indicium; and
collecting at least one image of the illuminated indicium.

10. The method as recited in claim 8, wherein projecting the image comprises:
activating at least one light source; and
manipulating light from the at least one light source to form an image from the light produced by the at least one light source.

11. The method as recited in claim 8, wherein the method further comprises retrieving projection data related to the decodable indicia from a memory and generating the image from the retrieved projection data.

12. A hand held indicia detecting and image projecting device comprising:
an indicia detecting assembly comprising image collecting optics adapted to collect light from a decodable indicium, and at least one photo detector adapted to detect light directed by the image collecting optics; and
an image projecting system adapted to project an image in response to the detected decodable indicium;
wherein the device is adapted to retrieve projection data related to the decodable indicium and provide the projection data to the image projecting system to produce the image.

13. The device as recited in claim 12, wherein the image projection system comprises a plurality of laser diodes or light-emitting diodes, a plurality stationery mirrors adapted to reflect light from the plurality of laser or light-emitting diodes, and a plurality of rotatable mirrors adapted to reflect light from the plurality of stationery mirrors.

14. The apparatus as recited in claim 1, wherein the image projecting system is adapted to project an image viewable by a plurality of individuals.

15. The method as recited in claim 8, wherein the projected image is viewable by a plurality of individuals.

16. The device as recited in claim 12, wherein the image projecting system is adapted to project an image viewable by a plurality of individuals.

17. The apparatus as recited in claim 1, wherein the image projected by the image projecting system comprises a decodable indicium detectable by a different image detecting system.

18. The method as recited in claim 8, wherein the projected image comprises an indicium detectable by the image detecting system, and wherein the method further comprises detecting the indicium projected by a different image projecting system.

19. The device as recited in claim 12, wherein the image projected by the image projecting system comprises a decodable indicium detectable by a different indicia detecting assembly.

20. The apparatus as recited in claim 1, wherein the indicia detecting system comprises an image sensor array.

21. The apparatus as recited in claim 20, wherein the image sensor array comprises one of a one-dimensional image sensor array and a two-dimensional image sensor array.

22. The method as recited in claim 9, wherein collecting at least one image of the illuminated indicium comprises collecting at least one image with an image sensor array.

23. The method as recited in claim 22, wherein the image sensor array comprises one of a one-dimensional image sensor array and a two-dimensional image sensor array.

24. The device as recited in claim 12, wherein the at least one photo detector comprises an image sensor array.

25. The device as recited in claim 24, wherein the image sensor array comprises one of a one-dimensional image sensor array and a two-dimensional image sensor array.
